(19) United States
(12) Patent Application Publication
(10) Pub. No.: US 2024/0367094 A1
(43) Pub. Date: Nov. 7, 2024

(54) PROCESS FOR PRODUCING A MATERIAL FOR ABSORBING CARBON DIOXIDE FROM ATMOSPHERIC AIR, MATERIAL FOR ABSORBING CARBON DIOXIDE FROM ATMOSPHERIC AIR, APPARATUS, MOTOR VEHICLE

(71) Applicant: Volkswagen Aktiengesellschaft, Wolfsburg (DE)

(72) Inventors: Christine SCHUETZ, Vordorf (DE); Marc RUEGGEBERG, Braunschweig (DE)

(73) Assignee: Volkswagen Aktiengesellschaft, Wolfsburg (DE)

(21) Appl. No.: 18/778,555

(22) Filed: Jul. 19, 2024

Related U.S. Application Data
(63) Continuation of application No. PCT/EP2023/051138, filed on Jan. 18, 2023.

(30) Foreign Application Priority Data
Jan. 19, 2022 (DE) 10 2022 101 205.0

(51) Int. Cl. B01D 53/14

(52) U.S. Cl. CPC B01D 53/1475; B01D 2252/10; B01D 2252/20421; B01D 2252/20426; B01D 2252/50; B01D 2257/504

(57) ABSTRACT

A process for producing a material that absorbs carbon dioxide from atmospheric air, comprising: using a material that has a core and terminal primary amine end groups; and epoxy end capping of the terminal primary amine end groups to give secondary amine end groups.

This nonprovisional application is a continuation of International Application No. PCT/EP2023/051138, which was filed on Jan. 18, 2023, and which claims priority to German Patent Application No. 10 2022 101 205.0, which was filed in Germany on Jan. 19, 2022, and which are both herein incorporated by reference.

### BACKGROUND OF THE INVENTION

### Field of the Invention

The invention relates to a process for producing an MMO that absorbs carbon dioxide from atmospheric air, an MMO, an apparatus, and a motor vehicle.

### Description of the Background Art

Mixed metal oxides (MMOs) are generally known for absorbing carbon dioxide from atmospheric air.

For example, in the essay “Sorbents for the Direct Capture of CO₂ from Ambient Air”, published in Angewandte Chemie 2020, 132, pp. 7048-7072, published by Wiley-VCH Verlag, Shi et al. describe various process of “direct air capture” (DAC).

The product Lewatit VP OC 1065 from LANXESS (see product data sheet) is known as a divinylbenzene crosslinked polymer in spherical bead form with primary amine groups, which is suitable for adsorbing atmospheric CO₂.

The scientific publication “Efficient CO₂ capture from ambient air with amine-functionalized Mg—Al mixed metal oxides” by Zhu et al., published in J. Mater. Chem. A, 2020, 8, pp. 16421-16428 describes amine-functionalized MMOs. However, they contain primary terminal amines.

Furthermore, the scientific publication “Direct air capture (DAC) of CO₂ using polyethyleneimine (PEI) “snow”: a scalable strategy” by Xu et al., published in Chem. Commun., 2020, 56, pp. 7151-7154, describes a polyethyleneimine to which CO₂ can bind. However, Xu et al. do not describe the use of MMOs.

### SUMMARY OF THE INVENTION

It is therefore an object of the present invention to provide a process, an MMO, an apparatus, and a motor vehicle that at least partially overcome the above-mentioned disadvantages.

The present disclosure relates to a process for producing a material for absorbing carbon dioxide from atmospheric air, comprising: using a material with a core and terminal primary amine end groups; and epoxy end capping of the terminal primary amine end groups to give secondary amine end groups.

The present disclosure also relates to a material for absorbing carbon dioxide from atmospheric air comprising terminal secondary amines.

The present disclosure also relates to an apparatus for capturing carbon dioxide from atmospheric air, comprising a material according to the second aspect.

The present disclosure also relates to a motor vehicle with an apparatus according to the third aspect.

DAC-suitable materials are generally known. However, it has been recognized that well-known MMOs can have poor aging properties-through the use of terminal primary amines. Therefore, it was recognized that MMOs that have secondary amine end groups can have better aging properties and can also lead to a better energy balance.

Therefore, some examples may relate to a process for producing a mixed metal oxide, MMO, for absorbing carbon dioxide from atmospheric air, comprising: manufacturing a layered MMO, wherein the MMO has terminal primary amine end groups; and epoxy end capping of the MMO's terminal amine primary end groups to give secondary amine end groups.

The mixed metal oxide (MMO) can include a well-known MMO, such as Mg—Al—CO₃, although the present disclosure is not limited to this. In general, mixed metal oxides produced from hydroxides can be used according to the present disclosure because they can enable efficient capture of CO₂ from atmospheric air.

An adsorbent may be manufactured to include adsorption materials that comprise other mesoporous materials such as silica (silicon dioxide), fumed silica, Zr-SBA-15, SBA-15, SBA-15+, PEG (polyethylene glycol), silica fiber, PE-MCM-41, MFC, or activated carbon, instead of [sic] or MMO.

The MMO manufactured according to the process of the disclosure can be used to absorb carbon dioxide from atmospheric air (e.g., applicable for direct air capture (DAC)). Atmospheric air means any gas mixture in which air can be found and any gas mixture that contains CO₂. Thus, according to the present process, CO₂ can be absorbed from any environment, such as atmospheric air, but also from exhaust gases or atmospheric air enriched with exhaust gases, such as an exhaust system of a vehicle (motor vehicle, ship, commercial vehicle, or the like) or an aircraft, from an exhaust pipe of a power plant (which produces CO₂), in an intake line (e.g., in a turbocharger), or similar.

A layered MMO can be manufactured, e.g., of hydroxides, as described above. The layered MMO manufactured according to the present process can have terminal primary amine end groups, wherein these can be capped according to the present process, e.g., based on an epoxy, so that the previously primary amine end groups become secondary amine end groups.

The MMO obtained according to the present disclosure can have a longer lifespan than known MMOs because it ages less quickly. Furthermore, a reduction of a desorption temperature can be achieved, because CO₂, in some embodiments, binds less strongly to secondary amine end groups than to primary amine end groups. This results in a better energy balance of a DAC process (or any other process in which CO₂ is to be absorbed).

It has been recognized that secondary amines lead to a longer lifetime than primary amines, which is why it has been recognized that the MMO's lifetime is increased if it has terminal secondary amine groups.

The epoxy may be any epoxy suitable for end capping, such as (poly-) ethylene oxide, (poly-) propylene oxide, or other (poly-) alkaloid oxides, wherein the present disclosure is not limited to alkaloid oxides. The choice of epoxy can depend on which end groups are to be capped.

However, the present disclosure is not limited to the use of amine groups. For example, imidazole groups (in addition to or as an alternative to amine groups) can be used and capped, although a different epoxy may be provided in such embodiments.

The epoxy can also be a mixture of different epoxies.

Accordingly, the epoxy can include ethylene oxide and/or propylene oxide.

For example, an MMO PEI (polyethylene imine) can be used, whose terminal groups are then capped as described herein.

The PEI can be branched or linear. When it is branched, a higher percentage of amines per area can be achieved, which allows for a higher adsorption capacity to be achieved.

Furthermore, it has been recognized that the MMOs offer an optimal specific surface for PEIs, so that the adsorption capacity is further increased than in well-known MMOs for DAC.

The MMO includes Mgₙ—Al—CO₃, wherein n is indicative of a molar ratio of Mg and Al.

Depending on the concentration of the epoxy and/or an additional adsorption material used, the efficiency of the MMO can be further adjusted by the molar ratio of the metals in the MMO, so that a maximum CO₂ absorption capacity of the MMO is achieved.

Manufacturing the layered MMOs includes: using an MMO precursor; adding a caustic solution and rinsing to obtain nanosheets; and calcination of the nanosheets.

The MMO precursor can be formed of a mixture of metal compounds. For example, if the MMO includes Mgₙ—Al—CO₃, the MMO precursor can include (Mg(NO₃)₂*6H₂O+Al(NO₃)₃*9H₂O). Such an MMO precursor can be mixed with Na₂CO₃ and the pH value of the mixture can be adjusted accordingly (e.g., to 10).

After the mixture has been exposed to this solution for an appropriate/predetermined period of time, it can be rinsed afterwards if necessary (e.g., with deionized water and/or solvent). After subsequent vacuum drying, nanosheets can then be obtained, which can be calcined to obtain the MMO.

For example, the AMOST method can be used to manufacture the MMO.

A mixed metal oxide, MMO, for absorbing carbon dioxide from atmospheric air may be provided, wherein the MMO has terminal secondary amines as described herein, which is manufactured, for example, by a process according to the present disclosure.

The terminal secondary amines are bound to epoxy, which can be bound to a metal oxide core.

The epoxy can include ethylene oxide and/or propylene oxide, as discussed herein.

A device is also provided for capturing carbon dioxide from atmospheric air, including an MMO, as discussed herein, which, e.g., is manufactured according to a process according to the present disclosure.

The device can, for example, can be designed as a filter, DAC module, or the like and can be used in different contexts, e.g., in an exhaust system and/or intake line of a motor vehicle, in a power plant, in cities, in nature, in the chemical industry where CO₂ is produced as a by-product (e.g., in combination with electrolysis and methanol synthesis after reverse water-gas shift reaction) or the like.

A motor vehicle is also provided, comprising a device for capturing atmospheric air, comprising an MMO according to the present disclosure.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a block diagram of a process for manufacturing an MMO according to the present disclosure; and

FIG. 2 schematically shows an example of a motor vehicle which has a device for capturing atmospheric air according to the present disclosure.

### DETAILED DESCRIPTION

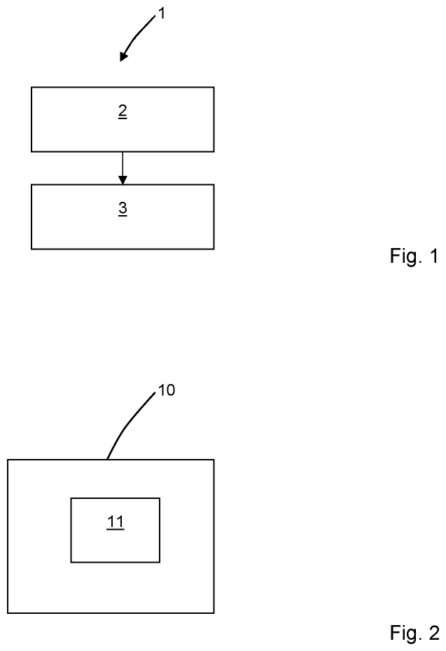

FIG. 1 shows an example of a process 1 for manufacturing an MMO (or a material in general, as described below) according to the present disclosure.

In 2, a material is used that has a core and terminal primary amine end groups, which in this embodiment includes manufacturing a layered MMO as described herein.

In 3, the primary amine end groups of the material are capped epoxy-based, as described herein.

FIG. 2 shows an embodiment of a motor vehicle 10 according to the present disclosure. The motor vehicle 10 comprises a device 11 which comprises a material for absorbing carbon dioxide according to the present disclosure. In this embodiment, the device 11 is provided in an intake line of a motor vehicle.

Some examples relate to a process for manufacturing a material for absorbing carbon dioxide from atmospheric air, comprising: using a material with a core and with terminal primary amine end groups; and epoxy-based end capping of the terminal primary amine end groups to give secondary amine end groups, as described herein.

Use may also include manufacture.

In some examples, the epoxy can include ethylene oxide and/or propylene oxide, as described herein.

In some examples, the core can include an MMO or activated carbon. In some embodiments, the MMO includes an MMO PEI.

It has been recognized that activated carbon has different thermal conductivity than, for example, an MMO. Activated carbon can warm up faster and cool faster, so there may not be a need to desorb at such high [sic-levels?] when using activated carbon.

Overall, activated carbon as a core has a better energy balance than known materials. Furthermore, it was recognized that activated carbon could be pretreated in an alkaline or acidic way, so that aging properties could be further improved, as an intermolecular interaction between activated carbon and (for example) polyethyleneimine can be improved with regard to aging.

In some examples, the MMO includes Mgₙ—Al—CO₃, wherein n is indicative of a molar ratio of Mg and Al, as described herein.

Some examples relate to a material for absorbing carbon dioxide from atmospheric air which has terminal secondary amines, as described herein. In some embodiments, the terminal secondary amines are bound to epoxy attached to a core, as described herein. In some embodiments, the epoxy includes ethylene oxide and/or propylene oxide.

Some examples include a device for capturing carbon dioxide from atmospheric air, comprising a substance for capturing carbon dioxide as described herein.

Some examples relate to a motor vehicle, including a device for capturing carbon dioxide from atmospheric air, as described herein.

The MMO's applications for absorbing CO₂ from atmospheric air are also applicable to the more general substance, as described herein, which can also include, for example, activated carbon, which is why a repetitive description of the above explanations is omitted at this point.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A process for manufacturing a material for absorbing carbon dioxide from atmospheric air, the process comprising:
using a material with a core and with a terminal primary amine end groups; and
epoxy-based end capping of the terminal primary amine end groups to give secondary amine end groups.

2. The process according to claim 1, wherein the epoxy comprises ethylene oxide and/or propylene oxide.

3. The process according to any one of the preceding claims, wherein the core comprises a mixed metal oxide, MMO, or activated carbon.

4. The process according to claim 3, wherein the MMO comprises Mgₙ—Al—CO₃, wherein n is indicative of a molar ratio of Mg and Al.

5. The process according to claim 3, wherein the MMO comprises an MMO polyethyleneimine.

6. A material for absorbing carbon dioxide from atmospheric air, the material comprising terminal secondary amines.

7. The material according to claim 6, wherein the terminal secondary amines are bound to epoxy bound to a core.

8. The material according to claim 6, wherein the epoxy comprises ethylene oxide and/or propylene oxide.

9. A device for capturing carbon dioxide from atmospheric air, comprising the material according to claim 6.

10. A motor vehicle, comprising the device according to claim 9.
